(19) United States
(12) Patent Application Publication
(10) Pub. No.: US 2024/0386050 A1
(43) Pub. Date: Nov. 21, 2024

(54) IMAGE SEARCH DEVICE, IMAGE SEARCH METHOD, AND STORAGE MEDIUM STORING IMAGE SEARCH PROGRAM

(71) Applicant: Mitsubishi Electric Corporation, Tokyo (JP)

(72) Inventors: Naohiro SHIBUYA, Tokyo (JP); Yoshimi MORIYA, Tokyo (JP)

(73) Assignee: Mitsubishi Electric Corporation, Tokyo (JP)

(21) Appl. No.: 18/789,070

(22) Filed: Jul. 30, 2024

Related U.S. Application Data
(63) Continuation of application No. PCT/JP2022/005773, filed on Feb. 15, 2022.

(51) Int. Cl. G06F 16/58

(52) U.S. Cl. CPC G06F 16/58

(57) ABSTRACT

An image search device includes a data acquiring unit to acquire image data captured by a camera and identification data indicating a type of the camera, and a common type specifying unit to specify a type common in types of feature amounts on the basis of a type of a camera. In addition, the image search device includes a feature amount extracting unit to extract a feature amount with respect to the type specified from the image indicated by each piece of the image data acquired, and an image search unit to compare a feature amount extracted from a query image with a feature amount extracted from each of one or more gallery images, and search for a gallery image in which the same subject as a subject appearing in the query image appears on the basis of a comparison result of the feature amounts.

### CROSS REFERENCE TO RELATED APPLICATION

This application is a Continuation of PCT International Application No. PCT/JP2022/005773, filed on Feb. 15, 2022, which is hereby expressly incorporated by reference into the present application.

### TECHNICAL FIELD

The present disclosure relates to an image search device, an image search method, and a storage medium storing an image search program.

### BACKGROUND ART

There is an image search device that searches for a gallery image in which the same subject as a subject appearing in a query image appears from among a plurality of gallery images (see, for example, Patent Literature 1).

The image search device includes a feature table that holds feature amounts extracted from each of the plurality of gallery images. Further, the image search device includes an image feature extracting unit that extracts a feature amount from a query image, and a feature collating unit that searches for a gallery image in which the same subject as a subject appearing in the query image appears from among the plurality of gallery images by collating each feature amount held in the feature table with the feature amount extracted by the image feature extracting unit.

### CITATION LIST

### Patent Literature

Patent Literature 1: JP 2015-2547 A

### SUMMARY OF INVENTION

### Technical Problem

In a case where the camera that has captured the query image and the camera that has captured the gallery image are different types of cameras, a type of a feature amount that can be extracted from the query image and a type of a feature amount that can be extracted from the gallery image may be different. Thus, in the image search device disclosed in Patent Literature 1, in a case where the camera that has captured the query image and the camera that has captured the gallery image are different types of cameras, the image feature extracting unit cannot always extract the same type of feature amount as the feature amount extracted from the gallery image from the query image. Therefore, in the image search device, in a case where the image feature extracting unit cannot extract the same type of feature amount from the query image, there is a problem that the feature collating unit cannot search for the gallery image in which the same subject as the subject appearing in the query image appears.

The present disclosure has been made to solve the above-described problems, and an object of the present disclosure is to obtain an image search device, an image search method, and an image search program capable of searching for a gallery image in which the same subject as a subject appearing in a query image appears, even if a camera that has captured the query image and a camera that has captured the gallery image are different types of cameras.

### Solution to Problem

An image search device according to the present disclosure includes a processor; and a memory storing a program, upon executed by the processor, to perform a process: to acquire image data indicating each of a plurality of images captured by a camera and identification data indicating a type of the camera that has captured each of the images; to specify a type common in types of feature amounts extractable from each of the images on a basis of a type of a camera indicated by each piece of the identification data acquired; to extract a feature amount with respect to the type specified from the image indicated by each piece of the image data acquired; and
to compare a feature amount extracted from a query image that is any one image included in the plurality of images among a plurality of feature amounts extracted with a feature amount extracted from each of one or more gallery images that are images other than the query image included in the plurality of images, and search for a gallery image in which a same subject as a subject appearing in the query image appears on a basis of a comparison result of the feature amounts.

### Advantageous Effects of Invention

According to the present disclosure, even if a camera that has captured a query image and a camera that has captured a gallery image are different types of cameras, it is possible to search for a gallery image in which the same subject as a subject appearing in the query image appears.

### BRIEF DESCRIPTION OF DRAWINGS

FIG. 1 is a configuration diagram illustrating an image search device 2 according to a first embodiment.

FIG. 2 is a hardware configuration diagram illustrating hardware of the image search device 2 according to the first embodiment.

FIG. 3 is a hardware configuration diagram of a computer in a case where the image search device 2 is implemented by software, firmware, or the like.

FIG. 4 is a flowchart illustrating an image search method which is a processing procedure of the image search device 2.

FIG. 5 is an explanatory diagram illustrating types of feature amounts that can be extracted from an image.

FIG. 6 is an explanatory diagram illustrating an example of a feature amount extracting method corresponding to a type of feature amount.

FIG. 7 is a configuration diagram illustrating an image search device 2 according to a second embodiment.

FIG. 8 is a hardware configuration diagram illustrating hardware of the image search device 2 according to the second embodiment.

FIG. 9 is a configuration diagram illustrating an image search device 2 according to a third embodiment.

FIG. 10 is a hardware configuration diagram illustrating hardware of the image search device 2 according to the third embodiment.

FIG. 11 is a configuration diagram illustrating an image search device 2 according to a fourth embodiment.

FIG. 12 is a hardware configuration diagram illustrating hardware of the image search device 2 according to the fourth embodiment.

### DESCRIPTION OF EMBODIMENTS

Hereinafter, in order to describe the present disclosure in more detail, embodiments for carrying out the present disclosure will be described with reference to the accompanying drawings.

### First Embodiment

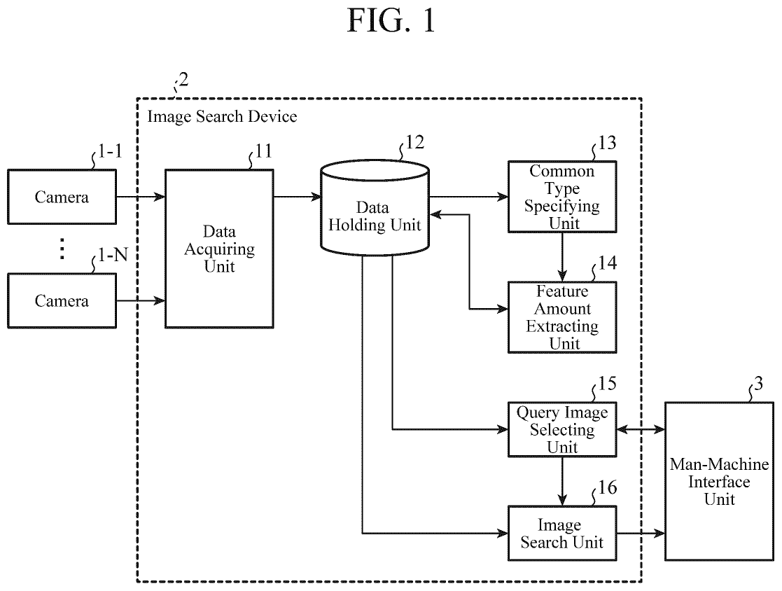

FIG. 1 is a configuration diagram illustrating an image search device 2 according to a first embodiment.

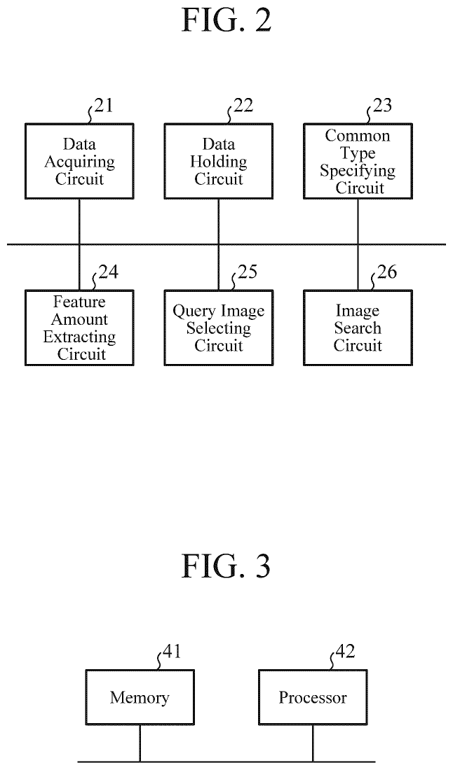

FIG. 2 is a hardware configuration diagram illustrating hardware of the image search device 2 according to the first embodiment.

In FIG. 1, cameras 1-1 to 1-N are installed at different places. N is an integer equal to or more than 2.

The camera 1-n (n=1, . . . , N) captures a person appearing at the installation place as a subject, and outputs image data indicating an image in which the subject appears to the image search device 2.

Further, the camera 1-n outputs identification data indicating the type of the camera to the image search device 2.

Here, the camera 1-n captures a person appearing at the installation place as a subject. However, this is merely an example, and the camera 1-n may capture, for example, a robot appearing at the installation place or an animal appearing at the installation place as a subject.

The image search device 2 includes a data acquiring unit 11, a data holding unit 12, a common type specifying unit 13, a feature amount extracting unit 14, a query image selecting unit 15, and an image search unit 16.

The image search device 2 is a device that searches for a gallery image in which the same subject as a subject appearing in a query image appears.

The man-machine interface unit 3 includes a man-machine interface such as a touch panel.

The man-machine interface unit 3 receives the selection of the query image and outputs a selection signal indicating the selected query image to the image search device 2.

Further, the man-machine interface unit 3 displays the gallery image retrieved by the image search device 2.

The data acquiring unit 11 is implemented by, for example, a data acquiring circuit 21 illustrated in FIG. 2.

The data acquiring unit 11 acquires image data indicating an image captured by the camera 1-n (n=1, . . . , N) and identification data indicating the type of the camera 1-n.

The data acquiring unit 11 outputs each of the image data and the identification data to the data holding unit 12.

The data holding unit 12 is implemented by, for example, a data holding circuit 22 illustrated in FIG. 2.

The data holding unit 12 holds each of the image data and the identification data output from the data acquiring unit 11.

Further, the data holding unit 12 holds a feature amount extracted by the feature amount extracting unit 14.

The common type specifying unit 13 is implemented by, for example, a common type specifying circuit 23 illustrated in FIG. 2.

The common type specifying unit 13 acquires each piece of the identification data acquired by the data acquiring unit 11 from the data holding unit 12.

The common type specifying unit 13 specifies a type common in types of feature amounts extractable from each of the images on the basis of the type of the camera 1-n (n=1, . . . , N) indicated by each piece of the identification data.

The common type specifying unit 13 outputs a specification result of the common type to the feature amount extracting unit 14.

The feature amount extracting unit 14 is implemented by, for example, a feature amount extracting circuit 24 illustrated in FIG. 2.

The feature amount extracting unit 14 acquires each piece of the image data acquired by the data acquiring unit 11 from the data holding unit 12.

The feature amount extracting unit 14 extracts a feature amount with respect to the type specified by the common type specifying unit 13 from an image indicated by each piece of the image data.

The feature amount extracting unit 14 outputs each feature amount to the data holding unit 12.

The query image selecting unit 15 is implemented by, for example, the query image selecting circuit 25 illustrated in FIG. 2.

The query image selecting unit 15 displays an image indicated by each piece of image data held in the data holding unit 12 on the touch panel of the man-machine interface unit 3.

The query image selecting unit 15 acquires a selection signal indicating a query image whose selection has been received by the man-machine interface unit 3.

The query image selecting unit 15 outputs the selection signal indicating the query image to the image search unit 16.

The image search unit 16 is implemented by, for example, an image search circuit 26 illustrated in FIG. 2.

The image search unit 16 acquires a feature amount extracted from the query image indicated by the selection signal output from the query image selecting unit 15 as a feature amount extracted from a query image from among a plurality of feature amounts held in the data holding unit 12.

The image search unit 16 compares the feature amount extracted from the query image indicated by the selection signal with the feature amount of each gallery image held in the data holding unit 12. The gallery image is an image other than the query image among a plurality of images held in the data holding unit 12.

The image search unit 16 searches for a gallery image in which the same subject as a subject appearing in the query image appears on the basis of a comparison result of the feature amounts.

For example, the image search unit 16 outputs the retrieved gallery image to the man-machine interface unit 3.

In FIG. 1, it is assumed that each of the data acquiring unit 11, the data holding unit 12, the common type specifying unit 13, the feature amount extracting unit 14, the query image selecting unit 15, and the image search unit 16, which are components of the image search device 2, is implemented by dedicated hardware as illustrated in FIG. 2. That is, it is assumed that the image search device 2 is implemented by the data acquiring circuit 21, the data holding circuit 22, the common type specifying circuit 23, the feature amount extracting circuit 24, the query image selecting circuit 25, and the image search circuit 26.

The data holding circuit 22 corresponds to, for example, a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disk, a compact disk, a mini disk, or a digital versatile disc (DVD).

Further, each of the data acquiring circuit 21, the common type specifying circuit 23, the feature amount extracting circuit 24, the query image selecting circuit 25, and the image search circuit 26 corresponds to, for example, a single circuit, a composite circuit, a programmed processor, a parallel-programmed processor, an application specific integrated circuit (ASIC), a field-programmable gate array (FPGA), or a combination thereof.

The components of the image search device 2 are not limited to those implemented by dedicated hardware, and the image search device 2 may be implemented by software, firmware, or a combination of software and firmware.

Software or firmware is stored in a memory of the computer as a program. The computer means hardware that executes a program, and corresponds to, for example, a central processing unit (CPU), a central processing device, a processing device, an arithmetic device, a microprocessor, a microcomputer, a processor, or a digital signal processor (DSP).

FIG. 3 is a hardware configuration diagram of a computer in a case where the image search device 2 is implemented by software, firmware, or the like.

In a case where the image search device 2 is implemented by software, firmware, or the like, the data holding unit 12 is configured on a memory 41 of the computer. An image search program for causing a computer to execute each processing procedure in the data acquiring unit 11, the common type specifying unit 13, the feature amount extracting unit 14, the query image selecting unit 15, and the image search unit 16 is stored in the memory 41. Then, the processor 42 of the computer executes the image search program stored in the memory 41.

Furthermore, FIG. 2 illustrates an example in which each of the components of the image search device 2 is implemented by dedicated hardware, and FIG. 3 illustrates an example in which the image search device 2 is implemented by software, firmware, or the like. However, this is merely an example, and some components in the image search device 2 may be implemented by dedicated hardware, and the remaining components may be implemented by software, firmware, or the like.

Next, the operation of the image search device 2 illustrated in FIG. 1 will be described.

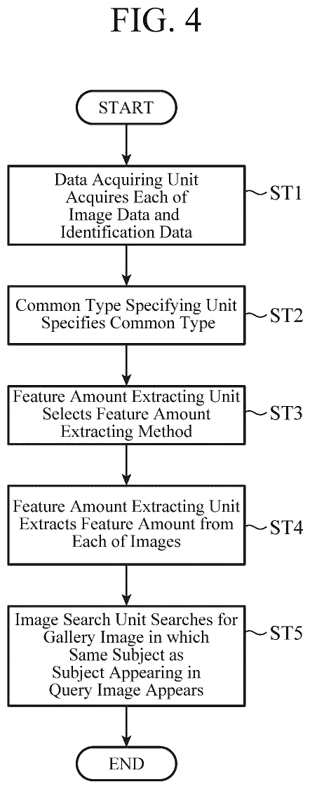

FIG. 4 is a flowchart illustrating an image search method which is a processing procedure of the image search device 2. The processing procedure of the image search device 2 includes a data acquisition processing procedure, a common type specifying processing procedure, a feature amount extraction processing procedure, and an image search processing procedure.

When a person appears at the installation place of the camera 1-n (n=1, . . . , N), the camera 1-n captures the person as a subject.

The camera 1-n outputs image data indicating an image in which the subject appears to the image search device 2.

The N cameras 1-1 to 1-N may be different types of cameras from each other, or may be the same type of cameras.

Examples of the camera 1-n include a visible camera, a depth camera, an infrared camera, and light detection and ranging (LiDAR).

Further, the camera 1-n outputs identification data indicating the type of the camera to the image search device 2.

The identification data is data indicating that the camera 1-n is a visible camera in a case where the camera 1-n is, for example, a visible camera, and indicating that the camera 1-n is a depth camera in a case where the camera 1-n is, for example, a depth camera. Further, the identification data is data indicating that the camera 1-n is an infrared camera in a case where the camera 1-n is, for example, an infrared camera, and indicating that the camera 1-n is a LiDAR in a case where the camera 1-n is, for example, a LiDAR.

When each of the image data and the identification data is output from the camera 1-n (n=1, . . . , N), the data acquiring unit 11 acquires each of the image data and the identification data (step ST1 in FIG. 4).

The data acquiring unit 11 outputs each of the image data and the identification data to the data holding unit 12.

The data holding unit 12 holds each of the image data and the identification data output from the data acquiring unit 11.

The common type specifying unit 13 acquires each piece of the identification data acquired by the data acquiring unit 11 from the data holding unit 12.

The common type specifying unit 13 specifies a type common in types of feature amounts extractable from each of the images on the basis of the type of the camera 1-n (n=1, . . . , N) indicated by each piece of the identification data (step ST2 in FIG. 4).

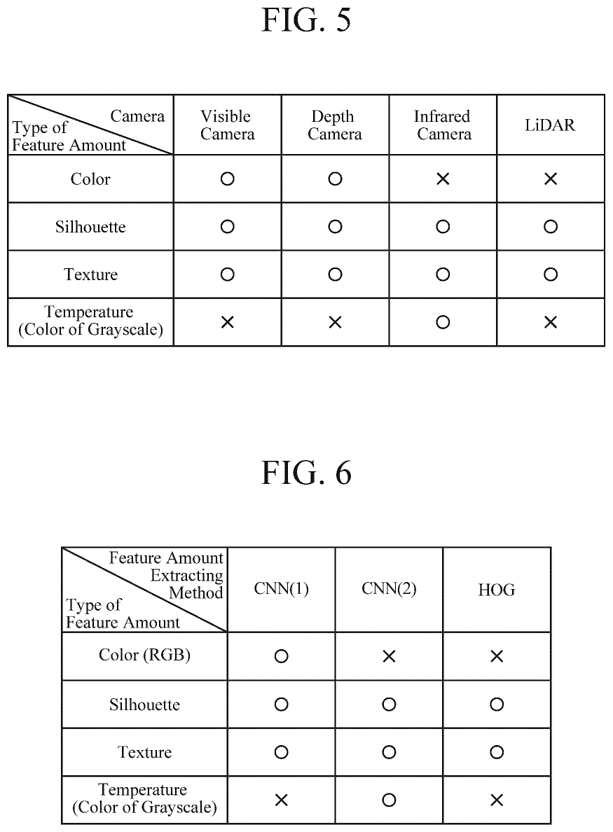

FIG. 5 is an explanatory diagram illustrating types of feature amounts that can be extracted from an image.

The example of FIG. 5 indicates that a type of a feature amount that can be extracted from each of an image captured by the visible camera and an image captured by the depth camera is color, silhouette, or texture.

Further, it is indicated that a type of a feature amount that can be extracted from an image captured by the infrared camera is silhouette, texture, or temperature.

It is indicated that a type of a feature amount that can be extracted from an image captured by LiDAR is silhouette or texture.

Therefore, for example, when N=2, if the camera 1-1 is a visible camera and the camera 1-2 is a depth camera, the common type specifying unit 13 specifies that a type common in types of feature amounts extractable from each of the images captured by the respective cameras is “color”, “silhouette”, or “texture”.

For example, when N=3, if the camera 1-1 is a visible camera, the camera 1-2 is a depth camera, and the camera 1-2 is an infrared camera, the common type specifying unit 13 specifies that a type common in types of feature amounts extractable from each of the images captured by the respective cameras is “silhouette” or “texture”.

The common type specifying unit 13 outputs a specification result of the common type to the feature amount extracting unit 14.

The feature amount extracting unit 14 acquires all the image data acquired by the data acquiring unit 11 from the data holding unit 12.

The feature amount extracting unit 14 acquires a specification result of the common type from the common type specifying unit 13.

The feature amount extracting unit 14 selects a feature amount extracting method capable of extracting a feature amount with respect to a type indicated by the specification result from among a plurality of feature amount extracting methods (step ST3 in FIG. 4).

FIG. 6 is an explanatory diagram illustrating an example of a feature amount extracting method corresponding to a type of a feature amount.

In the example of FIG. 6, in a case where the common type is “color”, a convolutional neural network (CNN) (1) can be used as the feature amount extracting method.

In a case where the common type is “silhouette” or “texture”, CNN (1), CNN (2), or Histogram of Oriented Gradients (HOG) can be used as the feature amount extracting method.

In a case where the common type is “temperature”, the CNN (2) can be used as the feature amount extracting method.

For example, in a case where the common type is “color”, the CNN (1) is a learning model that learns a feature amount with respect to “color” if image data indicating a color image is given as input data and a feature amount with respect to “color” extracted from the color image is given as training data at the time of learning. In a case where image data indicating a color image is given as input data at the time of inference, the CNN (1) outputs a feature amount with respect to “color” corresponding to the image data.

For example, in a case where the common type is “temperature”, the CNN (2) is a learning model that learns a feature amount with respect to “temperature” if image data indicating a grayscale infrared image is given as input data and a feature amount extracted from the infrared image is given as training data at the time of learning. In a case where image data indicating an infrared image is given as input data at the time of inference, the CNN (2) outputs a feature amount with respect to “temperature” corresponding to the image data.

For example, in a case where the common type is “color”, the feature amount extracting unit 14 selects the CNN (1) from the CNN (1), the CNN (2), and the HOG.

For example, in a case where the common type is “silhouette” or “texture”, the feature amount extracting unit 14 selects one of the CNN (1), the CNN (2), or the HOG from the CNN (1), the CNN (2), and the HOG.

For example, in a case where the common type is “temperature”, the feature amount extracting unit 14 selects the CNN (2) from the CNN (1), the CNN (2), and the HOG.

The feature amount extracting unit 14 extracts a feature amount with respect to the type specified by the common type specifying unit 13 from an image indicated by each piece of the image data using the selected feature amount extracting method (step ST4 in FIG. 4).

The feature amount extracting unit 14 outputs each feature amount to the data holding unit 12.

The data holding unit 12 holds each feature amount output from the feature amount extracting unit 14.

In a case where the user desires to search for a gallery image in which the same subject as a subject appearing in a query image appears, the user operates the man-machine interface unit 3 to request for execution of image search processing.

The man-machine interface unit 3 receives the request for execution of the image search processing, and outputs the request for execution of the image search processing to the query image selecting unit 15.

When the request for execution of the image search processing is output from the man-machine interface unit 3, the query image selecting unit 15 outputs all the image data held in the data holding unit 12 to the man-machine interface unit 3.

The man-machine interface unit 3 acquires all image data from the query image selecting unit 15, and displays images indicated by respective pieces of the image data on the display.

The user operates the man-machine interface unit 3 to select a query image from among all the images displayed on the display.

The man-machine interface unit 3 receives the selection of the query image and outputs a selection signal indicating the selected query image to the query image selecting unit 15.

The query image selecting unit 15 outputs the selection signal indicating the query image to the image search unit 16.

The image search unit 16 acquires the selection signal from the query image selecting unit 15.

The image search unit 16 acquires a feature amount extracted from the query image indicated by the selection signal from among a plurality of feature amounts held in the data holding unit 12.

Further, the image search unit 16 acquires a feature amount extracted from each of gallery images which are images other than the query image indicated by the selection signal from among the plurality of feature amounts held in the data holding unit 12.

The image search unit 16 compares the feature amount of the query image with the feature amount of each of the gallery images.

The image search unit 16 searches for a gallery image in which the same subject as a subject appearing in the query image appears on the basis of a comparison result of the feature amounts (step ST5 in FIG. 4).

Hereinafter, the search processing for the gallery image by the image search unit 16 will be specifically described.

Here, for convenience of description, it is assumed that the number of gallery images held in the data holding unit 12 is M (M is an integer equal to or more than 1), and a feature amount extracted from a gallery image Gₘ (m=1, . . . , M) is Fgₘ. Further, it is assumed that the feature amount extracted from a query image Q is Fq.

As a result of comparison between the feature amount Fq extracted from the query image Q and the feature amount Fgₘ extracted from the gallery image Gₘ, the image search unit 16 calculates a similarity S_{q,gm} between the feature amount Fq extracted from the query image Q and the feature amount Fgₘ extracted from the gallery image Gₘ.

Examples of a method of calculating the similarity S_{q,gm} include a method of calculating a Euclidean distance between the feature amount Fq extracted from the query image Q and the feature amount Fgₘ extracted from the gallery image Gₘ, and a method of calculating a cosine similarity between the feature amount Fq extracted from the query image Q and the feature amount Fgₘ extracted from the gallery image Gₘ.

The image search unit 16 searches for a gallery image Gⱼ in which the similarity S_{q,gm} with the feature amount Fq is larger than a threshold Th among M gallery images G₁ to G_{M} as a gallery image in which the same subject as a subject appearing in the query image Q appears. The threshold Th may be stored in an internal memory of the image search unit 16 or may be given from the outside of the image search device 2. j=1, . . . , J, and J is an integer equal to or more than 0 and equal to or less than M.

As image data indicating a gallery image in which the same subject as the subject appearing in the query image Q appears, the image search unit 16 outputs image data indicating the gallery image Gⱼ in which the similarity S_{q,gm} with the feature amount Fq is larger than the threshold Th to a monitoring device (not illustrated) or the like.

Further, the image search unit 16 outputs, to the man-machine interface unit 3, the image data indicating the gallery image Gⱼ in which the similarity S_{q,gm} with the feature amount Fq is larger than the threshold Th.

The man-machine interface unit 3 displays the gallery image Gⱼ on the display. By displaying the gallery image Gⱼ on the display, it is possible to track a person who is the subject.

In the above-described first embodiment, the image search device 2 is configured to include the data acquiring unit 11 to acquire image data indicating each of a plurality of images captured by the camera 1-n (n=1, . . . , N) and identification data indicating a type of the camera that has captured each of the images, and the common type specifying unit 13 to specify a type common in types of feature amounts extractable from each of the images on the basis of a type of a camera indicated by each piece of the identification data acquired by the data acquiring unit 11. Further, the image search device 2 includes the feature amount extracting unit 14 to extract a feature amount with respect to the type specified by the common type specifying unit 13 from the image indicated by each piece of the image data acquired by the data acquiring unit 11, and the image search unit 16 to compare a feature amount extracted from a query image that is any one image included in the plurality of images among a plurality of feature amounts extracted by the feature amount extracting unit 14 with a feature amount extracted from each of one or more gallery images that are images other than the query image included in the plurality of images, and search for a gallery image in which the same subject as a subject appearing in the query image appears on the basis of a comparison result of the feature amounts. Therefore, even if the camera that has captured the query image and the camera that has captured the gallery image are different types of cameras, the image search device 2 can search for the gallery image in which the same subject as the subject appearing in the query image appears.

In the image search device 2 illustrated in FIG. 1, the data acquiring unit 11 acquires the identification data from the camera 1-n. However, this is merely an example, and the data acquiring unit 11 may identify the type of the camera on the basis of image data acquired from the camera 1-n.

The data acquiring unit 11 can identify the type of the camera on the basis of, for example, an extension of image data or a data array of the image data. In this case, the data acquiring unit 11 outputs data indicating a type identification result to the data holding unit 12 as identification data.

Examples of the extension of the image data indicating an image captured by the visible camera include “.crw” or “.arw”. Examples of the extension of the image data indicating an image captured by the depth camera include “.heif” or “.heic”. Examples of the extension of the image data indicating an image captured by the infrared camera include “.iri” or “.six”. Examples of the extension of the image data indicating an image captured by LiDAR include “.obj” and “.dxf”.

### Second Embodiment

In a second embodiment, an image search device 2 including a feature amount compressing unit 17 that compresses each feature amount extracted by the feature amount extracting unit 14 will be described.

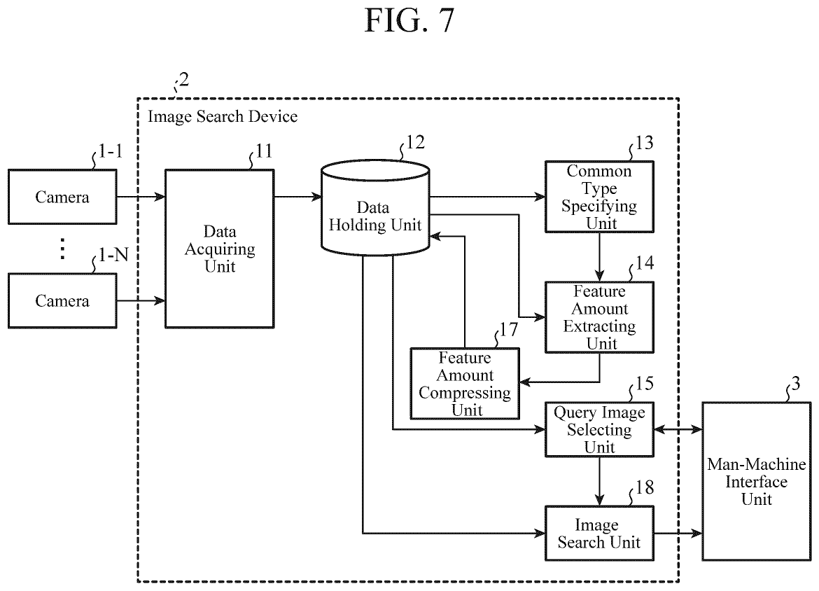

FIG. 7 is a configuration diagram illustrating the image search device 2 according to the second embodiment. In FIG. 7, the same reference numerals as those in FIG. 1 denote the same or corresponding parts, and thus description thereof is omitted.

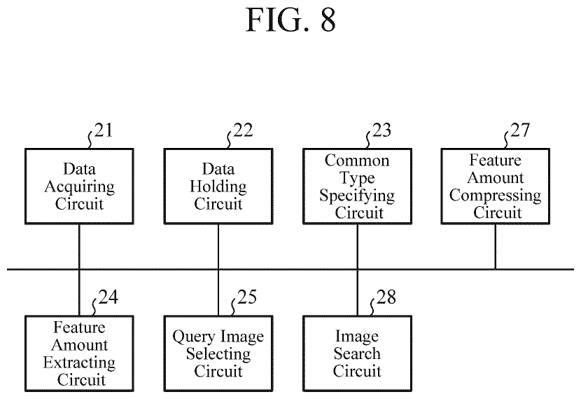

FIG. 8 is a hardware configuration diagram illustrating hardware of the image search device 2 according to the second embodiment. In FIG. 8, the same reference numerals as those in FIG. 2 denote the same or corresponding parts, and thus description thereof is omitted.

The image search device 2 illustrated in FIG. 7 includes a data acquiring unit 11, a data holding unit 12, a common type specifying unit 13, a feature amount extracting unit 14, the feature amount compressing unit 17, a query image selecting unit 15, and an image search unit 18.

The feature amount compressing unit 17 is implemented by, for example, a feature amount compressing circuit 27 illustrated in FIG. 8.

The feature amount compressing unit 17 compresses each of feature amounts extracted by the feature amount extracting unit 14, and outputs each of the feature amounts after compression to the data holding unit 12.

The data holding unit 12 holds feature amounts after compression by the feature amount compressing unit 17 instead of holding feature amounts extracted by the feature amount extracting unit 14.

The image search unit 18 is implemented by, for example, an image search circuit 28 illustrated in FIG. 8.

The image search unit 18 acquires a feature amount after compression related to a query image indicated by a selection signal output from the query image selecting unit 15 from among a plurality of feature amounts after compression held in the data holding unit 12.

The image search unit 18 compares the feature amount after compression related to the query image indicated by the selection signal with a feature amount after compression related to each of gallery images held in the data holding unit 12.

The image search unit 18 searches for a gallery image in which the same subject as a subject appearing in the query image appears on the basis of a comparison result of the feature amounts after compression.

For example, the image search unit 18 outputs the retrieved gallery image to the man-machine interface unit 3.

In FIG. 7, it is assumed that each of the data acquiring unit 11, the data holding unit 12, the common type specifying unit 13, the feature amount extracting unit 14, the feature amount compressing unit 17, the query image selecting unit 15, and the image search unit 18, which are components of the image search device 2, is implemented by dedicated hardware as illustrated in FIG. 8. That is, it is assumed that the image search device 2 is implemented by the data acquiring circuit 21, the data holding circuit 22, the common type specifying circuit 23, the feature amount extracting circuit 24, the feature amount compressing circuit 27, the query image selecting circuit 25, and the image search circuit 28.

The data holding circuit 22 corresponds to, for example, a nonvolatile or volatile semiconductor memory such as RAM, ROM, a flash memory, EPROM, or EEPROM, a magnetic disk, a flexible disk, an optical disk, a compact disk, a mini disk, or DVD.

Further, each of the data acquiring circuit 21, the common type specifying circuit 23, the feature amount extracting circuit 24, the feature amount compressing circuit 27, the query image selecting circuit 25, and the image search circuit 28 corresponds to, for example, a single circuit, a composite circuit, a programmed processor, a parallel-programmed processor, ASIC, FPGA, or a combination thereof.

The components of the image search device 2 are not limited to those implemented by dedicated hardware, and the image search device 2 may be implemented by software, firmware, or a combination of software and firmware.

In a case where the image search device 2 is implemented by software, firmware, or the like, the data holding unit 12 is configured on the memory 41 illustrated in FIG. 3. An image search program for causing a computer to execute each processing procedure in the data acquiring unit 11, the common type specifying unit 13, the feature amount extracting unit 14, the feature amount compressing unit 17, the query image selecting unit 15, and the image search unit 18 is stored in the memory 41 illustrated in FIG. 3. Then, the processor 42 illustrated in FIG. 3 executes the image search program stored in the memory 41.

Further, FIG. 8 illustrates an example in which each of the components of the image search device 2 is implemented by dedicated hardware, and FIG. 3 illustrates an example in which the image search device 2 is implemented by software, firmware, or the like. However, this is merely an example, and some components in the image search device 2 may be implemented by dedicated hardware, and the remaining components may be implemented by software, firmware, or the like.

Next, the operation of the image search device 2 illustrated in FIG. 7 will be described. It is similar to the image search device 2 illustrated in FIG. 1 except for the feature amount compressing unit 17 and the image search unit 18. Therefore, only the operations of the feature amount compressing unit 17 and the image search unit 18 will be described here.

The feature amount compressing unit 17 acquires each feature amount extracted by the feature amount extracting unit 14.

The feature amount compressing unit 17 compresses each feature amount by a compression method such as sparse coding.

The feature amount compressing unit 17 outputs each feature amount after compression to the data holding unit 12.

The data holding unit 12 holds each feature amount after compression by the feature amount compressing unit 17.

The image search unit 18 acquires a selection signal output from the man-machine interface unit 3.

The image search unit 18 acquires a feature amount after compression related to the query image indicated by the selection signal from among a plurality of feature amounts after compression held in the data holding unit 12.

Further, the image search unit 18 acquires a feature amount after compression related to each of gallery images which are images other than the query image indicated by the selection signal from among the plurality of feature amounts after compression held in the data holding unit 12.

The image search unit 18 compares the feature amount after compression related to the query image with the feature amount after compression related to each of the gallery images.

The image search unit 18 searches for a gallery image in which the same subject as a subject appearing in the query image appears on the basis of a comparison result of the feature amounts after compression.

Hereinafter, the search processing of the gallery image by the image search unit 18 will be specifically described.

Here, for convenience of description, it is assumed that the number of gallery images held in the data holding unit 12 is M (M is an integer equal to or more than 1), and a feature amount after compression related to a gallery image Gₘ (m=1, . . . , M) is CFgₘ. Further, it is assumed that the feature amount after compression related to the query image Q is CFq.

As a result of comparison between the feature amount CFq after compression related to the query image Q and the feature amount CFgₘ after compression related to the gallery image Gₘ, the image search unit 18 calculates a similarity CS_{q,gm} between the feature amount CFq after compression related to the query image Q and the feature amount CFgₘ after compression related to the gallery image Gₘ.

Examples of a method of calculating the similarity CS_{q,gm} include a method of calculating a Euclidean distance between the feature amount CFq after compression related to the query image Q and the feature amount CFgₘ after compression related to the gallery image Gₘ, and a method of calculating a cosine similarity between the feature amount CFq after compression related to the query image Q and the feature amount CFgₘ after compression related to the gallery image Gₘ.

The image search unit 18 searches for the gallery image Gⱼ in which the similarity CS_{q,gm} with the feature amount CFq is larger than the threshold The among M gallery images G₁ to G_{M} as a gallery image in which the same subject as a subject appearing in the query image Q appears. The threshold The may be stored in an internal memory of the image search unit 18 or may be given from the outside of the image search device 2. j=1, . . . , J, and J is an integer equal to or more than 0 and equal to or less than M.

As image data indicating a gallery image in which the same subject as the subject appearing in the query image Q appears, the image search unit 18 outputs image data indicating the gallery image Gⱼ in which the similarity CS_{q,gm} with the feature amount CFq is larger than the threshold Thc to a monitoring device (not illustrated) or the like.

Further, the image search unit 18 outputs, to the man-machine interface unit 3, the image data indicating the gallery image Gⱼ in which the similarity CS_{q,gm} with the feature amount CFq is larger than the threshold Thc.

The man-machine interface unit 3 displays the gallery image Gⱼ on the display.

In the above-described second embodiment, the image search device 2 illustrated in FIG. 7 is configured to include the feature amount compressing unit 17 to compress each of feature amounts extracted by the feature amount extracting unit 14, in which the image search unit 18 compares a feature amount after compression related to the query image with a feature amount after compression related to each of the gallery images among a plurality of feature amounts after compression by the feature amount compressing unit 17, and searches for a gallery image in which the same subject as the subject appearing in the query image appears on the basis of a comparison result of the feature amounts after compression. Therefore, similarly to the image search device 2 illustrated in FIG. 1, the image search device 2 illustrated in FIG. 7 can search for a gallery image in which the same subject as the subject appearing in the query image appears even if the camera that has captured the query image and the camera that has captured the gallery image are different types of cameras. Further, the calculation amount of the comparison processing in the image search unit 18 is reduced more than the calculation amount of the comparison processing in the image search unit 16 illustrated in FIG. 1.

### Third Embodiment

In a third embodiment, an image search device 2 including a data acquiring unit 19 that associates authentication information acquired from an authentication device 4 with an image captured by a camera 1-n will be described.

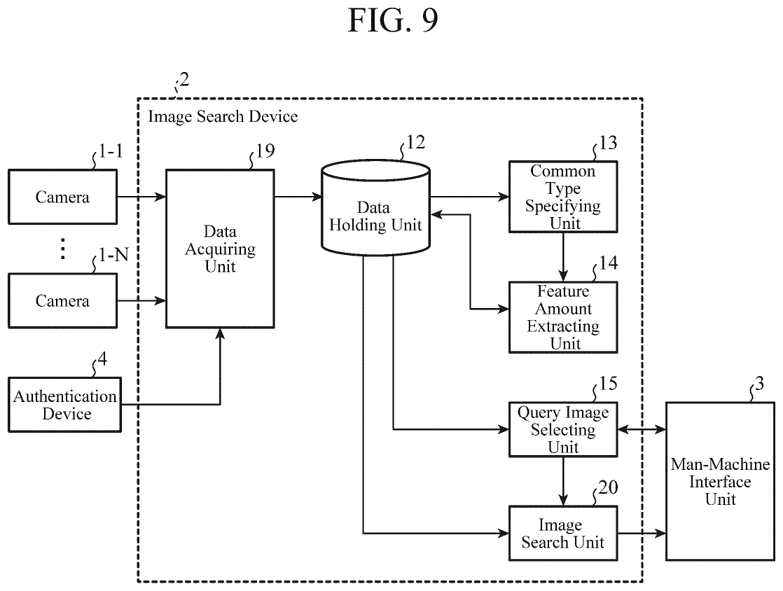

FIG. 9 is a configuration diagram illustrating the image search device 2 according to the third embodiment. In FIG. 9, the same reference numerals as those in FIGS. 1 and 7 denote the same or corresponding parts, and thus description thereof is omitted.

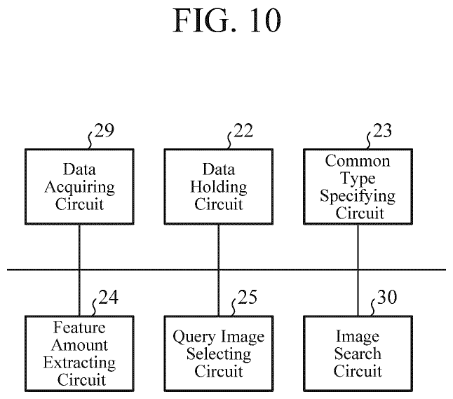

FIG. 10 is a hardware configuration diagram illustrating hardware of the image search device 2 according to the third embodiment. In FIG. 10, the same reference numerals as those in FIGS. 2 and 8 denote the same or corresponding parts, and thus description thereof is omitted.

For example, when an employee identification (ID) card is brought close by a person who appears at a place where the camera 1-n is installed, the authentication device 4 acquires authentication information of the person from the ID card. The person is a subject appearing in an image captured by the camera 1-n.

In the image search device 2 illustrated in FIG. 9, the authentication device 4 acquires authentication information of a person from an ID card. However, this is merely an example, and for example, the authentication device 4 may acquire authentication information of a person from a mobile terminal possessed by the person.

The authentication device 4 outputs the authentication information to the image search device 2.

The image search device 2 illustrated in FIG. 9 includes a data acquiring unit 19, a data holding unit 12, a common type specifying unit 13, a feature amount extracting unit 14, a query image selecting unit 15, and an image search unit 20.

In the image search device 2 illustrated in FIG. 9, each of the data acquiring unit 19 and the image search unit 20 is applied to the image search device 2 illustrated in FIG. 1. However, this is merely an example, and each of the data acquiring unit 19 and the image search unit 20 may be applied to the image search device 2 illustrated in FIG. 7.

The data acquiring unit 19 is implemented by, for example, a data acquiring circuit 29 illustrated in FIG. 10.

Similarly to the data acquiring unit 11 illustrated in FIG. 1, the data acquiring unit 19 acquires image data indicating an image captured by the camera 1-n (n=1, . . . , N) and identification data indicating the type of camera.

The data acquiring unit 19 acquires the authentication information from the authentication device 4, and associates the authentication information with the image captured by the camera 1-n.

The data acquiring unit 19 outputs each of the image data and the identification data to the data holding unit 12.

The image search unit 20 is implemented by, for example, an image search circuit 30 illustrated in FIG. 10.

Similarly to the image search unit 16 illustrated in FIG. 1, the image search unit 20 acquires a feature amount extracted from the query image indicated by a selection signal output from the query image selecting unit 15 as a feature amount extracted from a query image from among a plurality of feature amounts held in the data holding unit 12.

Similarly to the image search unit 16 illustrated in FIG. 1, the image search unit 20 compares the feature amount extracted from the query image indicated by the selection signal with the feature amount of each gallery image held in the data holding unit 12.

Similarly to the image search unit 16 illustrated in FIG. 1, the image search unit 20 searches for a gallery image in which the same subject as a subject appearing in the query image appears on the basis of a comparison result of the feature amounts.

Unlike the image search unit 16 illustrated in FIG. 1, in a case where the authentication information is associated with the query image, the image search unit 20 searches for a gallery image associated with the same authentication information as the authentication information associated with the query image.

For example, the image search unit 20 outputs the retrieved gallery image to the man-machine interface unit 3.

In FIG. 9, it is assumed that each of the data acquiring unit 19, the data holding unit 12, the common type specifying unit 13, the feature amount extracting unit 14, the query image selecting unit 15, and the image search unit 20, which are components of the image search device 2, is implemented by dedicated hardware as illustrated in FIG. 10. That is, it is assumed that the image search device 2 is implemented by the data acquiring circuit 29, the data holding circuit 22, the common type specifying circuit 23, the feature amount extracting circuit 24, the query image selecting circuit 25, and the image search circuit 30.

The data holding circuit 22 corresponds to, for example, a nonvolatile or volatile semiconductor memory such as RAM, ROM, a flash memory, EPROM, or EEPROM, a magnetic disk, a flexible disk, an optical disk, a compact disk, a mini disk, or DVD.

Further, each of the data acquiring circuit 29, the common type specifying circuit 23, the feature amount extracting circuit 24, the query image selecting circuit 25, and the image search circuit 30 corresponds to, for example, a single circuit, a composite circuit, a programmed processor, a parallel-programmed processor, ASIC, FPGA, or a combination thereof.

The components of the image search device 2 are not limited to those implemented by dedicated hardware, and the image search device 2 may be implemented by software, firmware, or a combination of software and firmware.

In a case where the image search device 2 is implemented by software, firmware, or the like, the data holding unit 12 is configured on the memory 41 of the computer. An image search program for causing a computer to execute processing procedures in the data acquiring unit 19, the common type specifying unit 13, the feature amount extracting unit 14, the query image selecting unit 15, and the image search unit 20 is stored in the memory 41 illustrated in FIG. 3. Then, the processor 42 illustrated in FIG. 3 executes the image search program stored in the memory 41.

Further, FIG. 10 illustrates an example in which each of the components of the image search device 2 is implemented by dedicated hardware, and FIG. 3 illustrates an example in which the image search device 2 is implemented by software, firmware, or the like. However, this is merely an example, and some components in the image search device 2 may be implemented by dedicated hardware, and the remaining components may be implemented by software, firmware, or the like.

Next, the operation of the image search device 2 illustrated in FIG. 9 will be described. It is similar to the image search device 2 illustrated in FIG. 1 except for the data acquiring unit 19 and the image search unit 20. Therefore, here, only the operations of the data acquiring unit 19 and the image search unit 20 will be mainly described.

The authentication device 4 may be installed at a place where each of the N cameras 1-1 to 1-N is installed.

For example, when N cameras 1-1 to 1-N are installed in a company, the authentication device 4 may be installed at an entrance of the company where the camera 1-1 is installed, and the authentication device 4 may be installed at an exit of the company where the camera 1-N is installed. It is assumed that the authentication device 4 is not installed at a place where each of the cameras 1-2 to 1-(N-1) is installed.

In such a case, when the ID card is brought close by the person appearing at the entrance of the company, the authentication device 4 installed at the entrance of the company acquires authentication information IDₖ of the person from the ID card, and outputs the authentication information IDₖ to the image search device 2. k is an integer equal to or more than 1. The authentication information IDₖ is a unique number or the like different for each person.

When the ID card is brought close by the person appearing at the exit of the company, the authentication device 4 installed at the exit of the company acquires the authentication information IDₖ of the person from the ID card, and outputs the authentication information IDₖ to the image search device 2.

Similarly to the data acquiring unit 11 illustrated in FIG. 1, the data acquiring unit 19 acquires image data indicating an image captured by the camera 1-n (n=1, . . . , N) and identification data indicating the type of camera.

In a case where the authentication device 4 is installed at the entrance of the company where the camera 1-1 is installed, the data acquiring unit 19 acquires the authentication information IDₖ from the authentication device 4 installed at the entrance of the company, and associates the authentication information IDₖ with an image captured by the camera 1-1.

That is, the data acquiring unit 19 adds the authentication information IDₖ to the image data indicating the image captured by the camera 1-1.

In a case where the authentication device 4 is installed at the exit of the company where the camera 1-N is installed, the data acquiring unit 19 acquires the authentication information IDₖ from the authentication device 4 installed at the exit of the company, and associates the authentication information IDₖ with an image captured by the camera 1-N.

That is, the data acquiring unit 19 adds the authentication information IDₖ to the image data indicating the image captured by the camera 1-N.

The data acquiring unit 19 outputs the image data indicating the image captured by the camera 1-n (n=1, . . . , N) and the identification data indicating the type of the camera to the data holding unit 12.

Here, the authentication information IDₖ is added to the image data indicating the image captured by the camera 1-1 and the image data indicating the image captured by the camera 1-N, and the authentication information IDₖ is not added to the image data indicating the image captured by the camera 1-n (n=2, . . . , N−1).

The data holding unit 12 holds each of the image data and the identification data output from the data acquiring unit 11.

Similarly to the image search unit 16 illustrated in FIG. 1, the image search unit 20 acquires a selection signal indicating the query image from the query image selecting unit 15.

Similarly to the image search unit 16 illustrated in FIG. 1, the image search unit 20 acquires a feature amount extracted from the query image indicated by the selection signal from among a plurality of feature amounts held in the data holding unit 12.

Further, similarly to the image search unit 16 illustrated in FIG. 1, the image search unit 20 acquires a feature amount extracted from each gallery image from among the plurality of feature amounts held in the data holding unit 12.

Similarly to the image search unit 16 illustrated in FIG. 1, the image search unit 20 compares the feature amount of the query image with the feature amount of each gallery image.

Similarly to the image search unit 16 illustrated in FIG. 1, the image search unit 20 searches for a gallery image in which the same subject as a subject appearing in the query image appears on the basis of a comparison result of the feature amounts.

For example, when the query image is an image captured by the camera 1-1, a subject appearing in the gallery images captured by the cameras 1-2 and 1-N may be the same as the subject appearing in the query image. In such a case, only the gallery image captured by the camera 1-2 may be retrieved as the gallery image in which the same subject as the subject appearing in the query image appears. For example, in a case where the subject wears a coat when captured by the cameras 1-1 and 1-2, but the subject does not wear the coat when captured by the camera 1-N, only the gallery image captured by the camera 1-2 may be retrieved as the gallery image in which the same subject as the subject appearing in the query image appears.

In a case where the authentication information IDₖ is added to the image data indicating the query image, the image search unit 20 searches for image data in which the same authentication information as the authentication information IDₖ is added among the image data indicated by one or more gallery images held in the data holding unit 12.

In a case where the authentication information IDₖ related to the same person is acquired by the authentication device 4 installed at the entrance of the company where the camera 1-1 is installed and the authentication device 4 installed at the exit of the company where the camera 1-N is installed, the gallery image captured by the camera 1-N is retrieved in addition to the gallery image captured by the camera 1-2.

For example, the image search unit 20 outputs the retrieved gallery image to the man-machine interface unit 3.

The man-machine interface unit 3 displays the retrieved gallery images on the display. By displaying the retrieved gallery images on the display, it is possible to track a person who is the subject.

In the above-described third embodiment, the image search device 2 illustrated in FIG. 9 is configured so that, in a case where the authentication device 4 is installed at a place where the camera 1-n is installed, the data acquiring unit 19 acquires authentication information of a subject appearing in an image captured by the camera 1-n from the authentication device 4, and associates the authentication information with the image captured by the camera 1-n. Further, the image search unit 20 of the image search device 2 illustrated in FIG. 9 is configured to, in a case where authentication information is associated with the query image, search for a gallery image with which the same authentication information as the authentication information associated with the query image is associated, in addition to searching for a gallery image in which the same subject as the subject appearing in the query image appears on the basis of the comparison result of the feature amounts. Therefore, similarly to the image search device 2 illustrated in FIG. 1, the image search device 2 illustrated in FIG. 9 can search for a gallery image in which the same subject as the subject appearing in the query image appears even if the camera that has captured the query image and the camera that has captured the gallery image are different types of cameras. Furthermore, when the subject is captured by each of the cameras 1-1 to 1-N, even if the clothes and the like of the subject change, it is possible to search for a gallery image in which the same subject as the subject appearing in the query image appears.

### Fourth Embodiment

In a fourth embodiment, an image search device 2 will be described in which a data acquiring unit 11′ extracts a region in which a subject appears from an image indicated by each piece of image data and outputs image data of the extracted region.

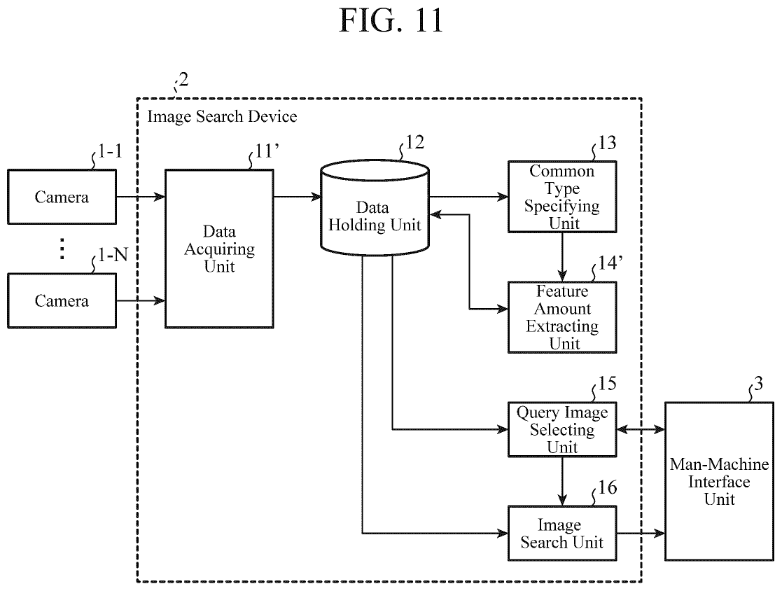

FIG. 11 is a configuration diagram illustrating the image search device 2 according to the fourth embodiment. In FIG. 11, the same reference numerals as those in FIGS. 1, 7, and 9 denote the same or corresponding parts, and thus description thereof is omitted.

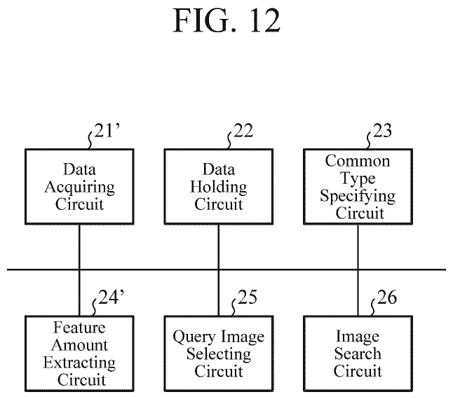

FIG. 12 is a hardware configuration diagram illustrating hardware of the image search device 2 according to the fourth embodiment. In FIG. 12, the same reference numerals as those in FIGS. 2, 8, and 10 denote the same or corresponding parts, and thus description thereof is omitted.

The image search device 2 includes a data acquiring unit 11′, a data holding unit 12, a common type specifying unit 13, a feature amount extracting unit 14′, a query image selecting unit 15, and an image search unit 16.

The data acquiring unit 11′ is implemented by, for example, a data acquiring circuit 21′ illustrated in FIG. 12.

The data acquiring unit 11′ acquires image data indicating an image captured by the camera 1-n (n=1, . . . , N) and identification data indicating the type of the camera.

The data acquiring unit 11′ extracts a region in which the subject appears from the image indicated by each piece of image data.

The data acquiring unit 11′ outputs each of the image data and the identification data of the extracted region to the data holding unit 12.

The feature amount extracting unit 14′ is implemented by, for example, a feature amount extracting circuit 24′ illustrated in FIG. 12.

The feature amount extracting unit 14′ acquires each piece of image data acquired by the data acquiring unit 11′ from the data holding unit 12.

The feature amount extracting unit 14′ extracts a feature amount with respect to the type specified by the common type specifying unit 13 from the image of the region indicated by each piece of image data.

The feature amount extracting unit 14′ outputs each feature amount to the data holding unit 12.

In the image search device 2 illustrated in FIG. 11, each of the data acquiring unit 11′ and the feature amount extracting unit 14′ is applied to the image search device 2 illustrated in FIG. 1. However, this is merely an example, and each of the data acquiring unit 11′ and the feature amount extracting unit 14′ may be applied to the image search device 2 illustrated in FIG. 7 or the image search device 2 illustrated in FIG. 9.

In FIG. 11, it is assumed that each of the data acquiring unit 11′, the data holding unit 12, the common type specifying unit 13, the feature amount extracting unit 14′, the query image selecting unit 15, and the image search unit 16, which are components of the image search device 2, is implemented by dedicated hardware as illustrated in FIG. 12. That is, it is assumed that the image search device 2 is implemented by the data acquiring circuit 21′, the data holding circuit 22, the common type specifying circuit 23, the feature amount extracting circuit 24′, the query image selecting circuit 25, and the image search circuit 26.

Each of the data acquiring circuit 21′, the common type specifying circuit 23, the feature amount extracting circuit 24′, the query image selecting circuit 25, and the image search circuit 26 corresponds to, for example, a single circuit, a composite circuit, a programmed processor, a parallel-programmed processor, ASIC, FPGA, or a combination thereof.

The components of the image search device 2 are not limited to those implemented by dedicated hardware, and the image search device 2 may be implemented by software, firmware, or a combination of software and firmware.

In a case where the image search device 2 is implemented by software, firmware, or the like, the data holding unit 12 is configured on the memory 41 of the computer. An image search program for causing a computer to execute processing procedures in the data acquiring unit 11′, the common type specifying unit 13, the feature amount extracting unit 14′, the query image selecting unit 15, and the image search unit 16 is stored in the memory 41 illustrated in FIG. 3. Then, the processor 42 illustrated in FIG. 3 executes the image search program stored in the memory 41.

Furthermore, FIG. 12 illustrates an example in which each of the components of the image search device 2 is implemented by dedicated hardware, and FIG. 3 illustrates an example in which the image search device 2 is implemented by software, firmware, or the like. However, this is merely an example, and some components in the image search device 2 may be implemented by dedicated hardware, and the remaining components may be implemented by software, firmware, or the like.

Next, the operation of the image search device 2 illustrated in FIG. 11 will be described. It is similar to the image search device 2 illustrated in FIG. 1 except for the data acquiring unit 11′ and the feature amount extracting unit 14′. Therefore, only the operations of the data acquiring unit 11′ and the feature amount extracting unit 14′ will be described here.

When each of the image data and the identification data is output from the camera 1-n (n=1, . . . , N), the data acquiring unit 11′ acquires each of the image data and the identification data.

The data acquiring unit 11′ extracts a region in which the subject appears from the image indicated by each piece of image data.

The shape of the region in which the subject appears is, for example, a rectangle. As a method of extracting a rectangular region, for example, there is a method of extracting a rectangular region using a pre-learned model such as a single shot multibox detector (SSD) in addition to a method of searching a maximum inclusion rectangle from a foreground-extracted region such as a background difference.

By the data acquiring unit 11′ extracting the region in which the subject appears, the feature amount extracted by the feature amount extracting unit 14′ is substantially the feature amount of the subject.

The data acquiring unit 11′ outputs each of the image data and the identification data of the extracted region to the data holding unit 12.

The data holding unit 12 holds each of the image data and the identification data of the region output from the data acquiring unit 11′.

In the image search device 2 illustrated in FIG. 11, the data acquiring unit 11′ extracts a rectangular region in which the subject appears. However, the region extracted by the data acquiring unit 11′ only needs to be a region in which the subject appears, and thus the shape of the region extracted by the data acquiring unit 11′ is not limited to a rectangle and may be, for example, a circle or a polygon other than a quadrangle.

The feature amount extracting unit 14′ acquires all the image data acquired by the data acquiring unit 11′ from the data holding unit 12.

The feature amount extracting unit 14′ acquires a specification result of the common type from the common type specifying unit 13.

The feature amount extracting unit 14′ selects a feature amount extracting method capable of extracting a common type of feature amount from a plurality of feature amount extracting methods, similarly to the feature amount extracting unit 14 illustrated in FIG. 1.

The feature amount extracting unit 14′ extracts a feature amount from an image indicated by each piece of image data using the selected feature amount extracting method.

The feature amount extracting unit 14′ outputs each feature amount to the data holding unit 12.

The data holding unit 12 holds each feature amount output from the feature amount extracting unit 14′.

The feature amount extracted by the feature amount extracting unit 14′ is generally the feature amount of the subject. On the other hand, the feature amount extracted by the feature amount extracting unit 14 illustrated in FIG. 1 includes the feature amount of the background and the like in addition to the feature amount of the subject. Therefore, the image search unit 16 illustrated in FIG. 11 has higher search accuracy of a gallery image in which the same subject as the subject appearing in the query image appears than the image search unit 16 illustrated in FIG. 1.

In the above-described fourth embodiment, the image search device 2 illustrated in FIG. 11 is configured so that the data acquiring unit 11′ extracts a region in which a subject appears from an image indicated by each piece of image data and outputs image data of the region. Further, the feature amount extracting unit 14′ of the image search device 2 illustrated in FIG. 11 is configured to extract the feature amount with respect to the type specified by the common type specifying unit 13 from the image of the region indicated by each piece of image data output from the data acquiring unit 11′. Therefore, similarly to the image search device 2 illustrated in FIG. 1, the image search device 2 illustrated in FIG. 11 can search for a gallery image in which the same subject as the subject appearing in the query image appears even if the camera that has captured the query image and the camera that has captured the gallery image are different types of cameras. In addition, the image search device 2 illustrated in FIG. 11 can enhance the search accuracy of the gallery image in which the same subject as the subject appearing in the query image appears, as compared with the image search device 2 illustrated in FIG. 1.

Note that, in the present disclosure, free combinations of the embodiments, modifications of any components of the embodiments, or omissions of any components in the embodiments are possible.

### INDUSTRIAL APPLICABILITY

The present disclosure is suitable for an image search device, an image search method, and an image search program.

### REFERENCE SIGNS LIST

1-1 to 1-N: camera, 2: image search device, 3: man-machine interface unit, 4: authentication device, 11, 11′: data acquiring unit, 12: data holding unit, 13: common type specifying unit, 14, 14′: feature amount extracting unit, 15: query image selecting unit, 16: image search unit, 17: feature amount compressing unit, 18: image search unit, 19: data acquiring unit, 20: image search unit, 21, 21′: data acquiring circuit, 22: data holding circuit, 23: common type specifying circuit, 24, 24′: feature amount extracting circuit, 25: query image selecting circuit, 26: image search circuit, 27: feature amount compressing circuit, 28: image search circuit, 29: data acquiring circuit, 30: image search circuit, 41: memory, 42: processor

1. An image search device comprising:
a processor; and
a memory storing a program, upon executed by the processor, to perform a process:
to acquire image data indicating each of a plurality of images captured by a camera and identification data indicating a type of the camera that has captured each of the images;
to specify a type common in types of feature amounts extractable from each of the images on a basis of a type of a camera indicated by each piece of the identification data acquired;
to extract a feature amount with respect to the type specified from the image indicated by each piece of the image data acquired; and
to compare a feature amount extracted from a query image that is any one image included in the plurality of images among a plurality of feature amounts extracted with a feature amount extracted from each of one or more gallery images that are images other than the query image included in the plurality of images, and search for a gallery image in which a same subject as a subject appearing in the query image appears on a basis of a comparison result of the feature amounts.

2. The image search device according to claim 1, wherein
the process further comprises to,
instead of acquiring the identification data indicating the type of the camera that has captured each of the images, identify the type of the camera that has captured each of the images on a basis of each piece of the image data, and outputs data indicating an identification result of the type as the identification data.

3. The image search device according to claim 1, wherein
the process further comprises to
select a feature amount extracting method capable of extracting a feature amount with respect to the type specified from a plurality of feature amount extracting methods, and a feature amount is extracted from an image indicated by each piece of the image data acquired using the selected feature amount extracting method.

4. The image search device according to claim 1, the process further comprising:
to compress each of feature amounts extracted, wherein
the process
compares a feature amount after compression related to the query image with a feature amount after compression related to each of the gallery images among a plurality of feature amounts after compression, and searches for a gallery image in which a same subject as the subject appearing in the query image appears on a basis of a comparison result of the feature amounts after compression.

5. The image search device according to claim 1, wherein
the process further comprises to,
in a case where an authentication device is installed at a place where the camera is installed, acquire authentication information of a subject appearing in an image captured by the camera from the authentication device, and associates the authentication information with the image captured by the camera, and
the process further comprises to,
in a case where authentication information is associated with the query image, search for a gallery image with which same authentication information as the authentication information associated with the query image is associated, in addition to searching for a gallery image in which a same subject as the subject appearing in the query image appears on a basis of a comparison result of the feature amounts.

6. The image search device according to claim 1, wherein
the process further comprises to
extract a region in which a subject appears from an image indicated by each piece of image data, and outputs image data of the region, and
the process further comprises to
extract a feature amount with respect to the type specified from an image of a region indicated by each piece of the image data output.

7. An image search method comprising:
acquiring image data indicating each of a plurality of images captured by a camera and identification data indicating a type of the camera that has captured each of the images;
specifying a type common in types of feature amounts extractable from each of the images on a basis of a type of a camera indicated by each piece of the identification data acquired;
extracting a feature amount with respect to the type specified from the image indicated by each piece of the image data acquired; and
comparing a feature amount extracted from a query image that is any one image included in the plurality of images among a plurality of feature amounts extracted with a feature amount extracted from each of one or more gallery images that are images other than the query image included in the plurality of images, and searching for a gallery image in which a same subject as a subject appearing in the query image appears on a basis of a comparison result of the feature amounts.

8. A non-transitory, tangible, computer-readable storage medium storing an image search program for causing a computer to execute:
acquiring image data indicating each of a plurality of images captured by a camera and identification data indicating a type of the camera that has captured each of the images;
specifying a type common in types of feature amounts extractable from each of the images on a basis of a type of a camera indicated by each piece of the identification data acquired;
extracting a feature amount with respect to the type specified from the image indicated by each piece of the image data acquired; and
comparing a feature amount extracted from a query image that is any one image included in the plurality of images among a plurality of feature amounts extracted with a feature amount extracted from each of one or more gallery images that are images other than the query image included in the plurality of images, and searching for a gallery image in which a same subject as a subject appearing in the query image appears on a basis of a comparison result of the feature amounts.
